(19) United States
(12) Patent Application Publication
(10) Pub. No.: US 2022/0120330 A1
(43) Pub. Date: Apr. 21, 2022

(54) STAND AND DISPLAY APPARATUS INCLUDING THE SAME

(71) Applicant: SAMSUNG ELECTRONICS CO., LTD., Suwon-si (KR)

(72) Inventors: Hyun Young CHOI, Suwon-si (KR); Ji Su KIM, Suwon-si (KR); Dae Sik YOON, Suwon-si (KR); Woo Sung IN, Suwon-si (KR); Hyun Jun JUNG, Suwon-si (KR); Dae Su CHOI, Suwon-si (KR)

(73) Assignee: SAMSUNG ELECTRONICS CO., LTD., Suwon-si (KR)

(21) Appl. No.: 17/419,121

(22) PCT Filed: Mar. 21, 2019
(86) PCT No.: PCT/KR2019/003303

§ 371 Date: Jun. 28, 2021

(30) Foreign Application Priority Data
Jan. 14, 2019 (KR) 10-2019-0004548

(51) Int. Cl. F16F 15/04; F16M 11/22

(52) U.S. Cl. CPC F16F 15/04; F16F 2230/0029; F16M 2200/08; F16M 11/22

(57) ABSTRACT

The present disclosure relates to a stand having an improved structure to stably support a display module, and a display apparatus including the same. The stand is configured to support a display module. The stand includes a base assembly including a first base and a second base coupled to the first base, a support bar extending in a height direction of the stand to be coupled to the base assembly, a first vibration damper installed on the first base, the first vibration damper including a moving member exposed to the outside of the first base and provided to move in the height direction of the stand, and a second vibration damper installed on the second base, the second vibration damper including a rotation member provided to exposed to the outside of the second base and move in the height direction of the stand and rotatably provided to impart mobility to the stand.

### TECHNICAL FIELD

The present disclosure relates to a stand and a display apparatus including the same, and more particularly, to a stand having an improved structure to stably support a display module, and a display apparatus including the same.

### BACKGROUND ART

A display apparatus is a type of an output apparatus that visually displays data information such as characters and graphics, and images or the like.

The display apparatus may include a self-light emitting display panel such as an organic light emitting diode (OLED) or a light-receiving/emitting display panel such as a liquid crystal display (LCD).

The display apparatus may further include a stand provided to support the display panel. The stand may include a support bar coupled to a base so that the base and the display panel are mounted thereto.

When the coupling between the base and the support bar which constitutes the stand, is not sturdy, the support bar coupled to the base may be shaken. When the support bar is shaken, the display panel mounted on the support bar may also be shaken, which may cause inconvenience to a user. In addition, the display panel may fall to a floor and be damaged due to a non-sturdy coupling between the base and the support bar of the stand.

### DISCLOSURE

### Technical Problem

The present disclosure is directed to providing a stand having an improved structure to prevent shaking and a display apparatus including the same.

### Technical Solution

An aspect of the present disclosure provides a stand configured to support a display module. The stand may include a base assembly including a first base and a second base coupled to the first base, a support bar extending in a height direction of the stand to be coupled to the base assembly, a first vibration damper installed on the first base, the first vibration damper including a moving member exposed to the outside of the first base and provided to move in the height direction of the stand, and a second vibration damper installed on the second base, the second vibration damper including a rotation member provided to exposed to the outside of the second base and move in the height direction of the stand and rotatably provided to impart mobility to the stand.

The first vibration damper may further include a moving member holder disposed inside the first base to hold the moving member, and a first elastic body installed inside the moving member holder to elastically support the moving member.

The first base may include a bottom outer frame having a moving member passing hole through which the moving member passes, a top outer frame coupled to the bottom outer frame to form an outer appearance of the first base together with the bottom outer frame, and an inner frame disposed between the bottom outer frame and the top outer frame.

The moving member holder may include a top holder fixed to an inner surface of an upper wall of the inner frame directing upward of the stand, and a bottom holder fixed to an inner surface of a lower wall of the bottom outer frame facing the inner surface of the upper wall of the inner frame, coupled to the top holder so that the first elastic body is accommodated therein, and including a moving member coupling hole to which the moving member is coupled.

The first elastic body may be elastically deformable in the height direction of the stand, and one end of the first elastic body may be coupled to the top holder and the other end of the first elastic body may be coupled to the moving member.

The first base may be positioned in the front of the second base to direct to the same direction as the display module.

The second base may extend in a left-right direction of the stand, and the second vibration damper may include a rotation member holder provided to seat the rotation member and coupled to the second base, and a rotation shaft seated on the rotation member holder so that the rotation member is rotatably coupled and extending in a left-right direction of the stand.

The second vibration damper may further include a second elastic body installed between an upper wall of the second base and the rotation member holder to elastically support the rotation member.

The second elastic body may be elastically deformable in the height direction of the stand, and one end of the second elastic body may be coupled to the upper wall of the second base and the other end of the second elastic body may be coupled to the rotation member holder.

The stand may further include a mount holder provided to mount the display module thereon, a first connection bracket having one end coupled to the mount holder and the other end being accommodated in and coupled to the support bar, to connect the mount holder and the support bar, the first connection bracket having an opening, and a first movement preventer provided to reduce a gap between the first connection bracket and the support bar, the first movement preventer including a moving block provided to enable to protrude through the opening of the first connection bracket to come into contact with an inner surface of the support bar.

The first movement preventer may further include a guide block having an inclined surface along which the moving block moves, and a guide pin penetrating through and coupled to the guide block in a front-rear direction of the stand and provided to enable to press the guide block from the rear of the stand.

When the guide pin is pressed from the rear of the stand, the moving block may move along the inclined surface of the guide block to protrude through the opening of the first connection bracket.

The stand may further include a second connection bracket having one end coupled to the base assembly and the other end being accommodated in and coupled to the support bar, to connect the base assembly and the support bar, the second connection bracket having an opening, and a second movement preventer provided to reduce a gap between the second connection bracket and the support bar, the second movement preventer including a moving block provided to enable to protrude through the opening of the second connection bracket to come into contact with an inner surface of the support bar.

The second movement preventer may further include a guide block having an inclined surface along which the moving block moves, and a guide pin penetrating through and coupled to the guide block in a front-rear direction of the stand and provided to enable to press the guide block from the rear of the stand.

When the guide pin is pressed from the rear of the stand, the moving block may move along the inclined surface of the guide block to protrude through the opening of the second connection bracket.

Another aspect of the present disclosure provides a display apparatus including a display module configured to display an image and a stand configured to mount the display module thereon. The stand may include a base assembly including a plurality of first bases disposed to direct to the same direction as the display module mounted on the stand and a second base disposed in the rear of the plurality of first bases, a support bar extending in a height direction of the stand and coupled to the base assembly, a plurality of first vibration preventer installed on the plurality of first bases, each of the plurality of first vibration dampers including a moving member provided to enable to protrude to the outside of a lower wall of each of the plurality of first bases according to movement in the height direction of the stand, and a plurality of second vibration preventers installed on the second base, each of the plurality of first vibration dampers including a rotation member provided to move in the height direction of the stand and rotatably provided to impart mobility to the stand.

The plurality of second vibration dampers may be located outside the plurality of first vibration dampers in a left-right direction of the stand.

The plurality of first bases may include a right base positioned on the right side with respect to a reference line extending in a front-rear direction of the stand to pass through the support bar and on which one of the plurality of first vibration dampers is installed, and a left base positioned on the left side with respect to the reference line extending in the front-rear direction of the stand to pass through the support bar and on which the other one of the plurality of first vibration dampers is installed.

Each of the plurality of first vibration dampers may further include a moving member holder disposed inside each of the plurality of first bases to hold the moving member, and a first elastic body installed inside the moving member holder to elastically support the moving member.

The second base may extend in the left-right direction of the stand, and each of the plurality of second vibration dampers may further include a rotation member holder provided such that the rotation member is seated therein and to be coupled to the second base, a rotation shaft seated in the rotation member holder so that the rotation member is rotatably coupled thereto and extending in the left-right direction of the stand, and a second elastic body installed between an upper wall of the second base and the rotation member holder to elastically support the rotation member.

### Advantageous Effects

By at least one movement preventer installed on a stand, a gap between a first connection bracket and a support bar or a gap between a second connection bracket and the support bar can be reduced so that the shaking of the stand can be effectively prevented.

Further, together with the at least one movement preventer, by at least one vibration damper installed on the stand, not only can the shaking of the stand be reduced, but also the stand can be stably installed on an installation surface regardless of the state of the installation surface.

### DESCRIPTION OF DRAWINGS

FIG. 1 is a perspective view illustrating a display apparatus according to an embodiment of the present disclosure.

FIG. 2 is a perspective view illustrating a stand of the display apparatus according to an embodiment of the present disclosure.

FIG. 3 is an exploded perspective view illustrating the stand of the display apparatus according to an embodiment of the present disclosure.

FIG. 4 is a view illustrating a rear surface of a base assembly in the stand of the display apparatus according to an embodiment of the present disclosure.

FIG. 5 is an exploded perspective view illustrating a first vibration damper in the stand of the display apparatus according to an embodiment of the present disclosure.

FIG. 6 is a cross-sectional view taken along line A-A′ in FIG. 4 illustrating the stand of the display apparatus according to an embodiment of the present disclosure.

FIGS. 7a and 7b are exploded perspective views illustrating a second vibration damper in different directions in the stand of the display apparatus according to an embodiment of the present disclosure.

FIG. 8 is a cross-sectional view taken along line B-B′ in FIG. 4 illustrating the stand of the display apparatus according to an embodiment of the present disclosure.

FIG. 9 is an exploded perspective view of a part of the stand of the display apparatus according to an embodiment of the present disclosure.

FIGS. 10a and 10b are views illustrating an operation process of a first movement preventer in the stand of the display apparatus according to an embodiment of the present disclosure.

FIG. 11 is an exploded perspective view of another part of the stand of the display apparatus according to an embodiment of the present disclosure.

FIGS. 12a and 12b are views illustrating an operation process of a second movement preventer in the stand of the display apparatus according to an embodiment of the present disclosure.

### MODE OF THE DISCLOSURE

Hereinafter, an embodiment of the present disclosure will be described in detail with reference to the accompanying drawings. In this specification, the terms “front end,” “rear end,” “upper portion,” “lower portion,” “upper end” and “lower end” used in the following description are defined with reference to the drawings, and the shape and position of each component are not limited by these terms.

Hereinafter, an electronic blackboard will be mainly described as an example of a display apparatus. However, the display apparatus is sufficient as long as it is an apparatus capable of displaying an image, and the type of the display apparatus is not limited to the electronic board.

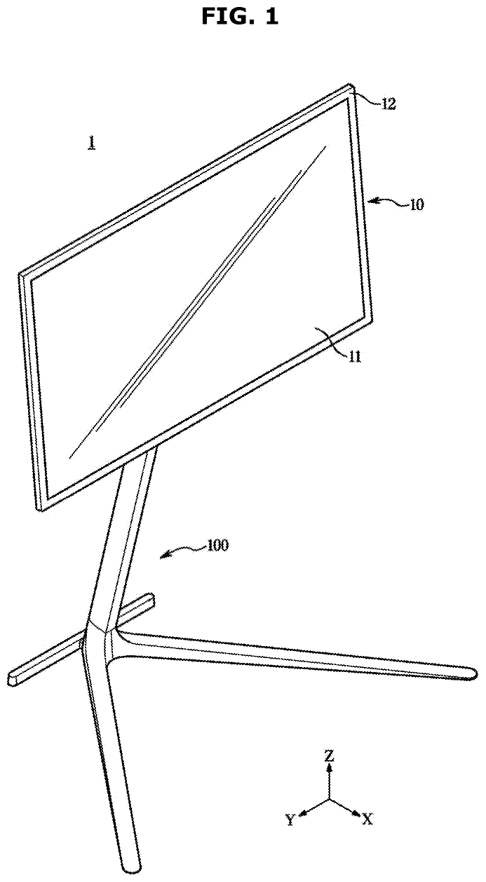

FIG. 1 is a perspective view illustrating a display apparatus according to an embodiment of the present disclosure.

As illustrated in FIG. 1, a display apparatus 1 may include a display module 10 provided to display an image. The display module 10 may include a display panel 11 on which an image is displayed, a display unit (not shown) provided to form an image, and a frame 12 provided to accommodate the display panel 11 and the display unit and forming an outer appearance of the display module 10.

The display panel 11 may include a self-light emitting display panel such as an organic light emitting diode (OLED) or a light-receiving/emitting display panel such as a liquid crystal display (LCD).

When the display panel 11 is a light-receiving/emitting display panel, the display unit may include a backlight unit (BLU) (not shown) provided to supply light to the display panel 11.

The display panel 11 may be implemented in a touch screen manner.

The display apparatus 1 may further include a stand 100 provided such that the display module 10 is mounted thereon. That is, the stand 100 may be provided to support the display module 10. A detailed description of the stand 100 will be described later.

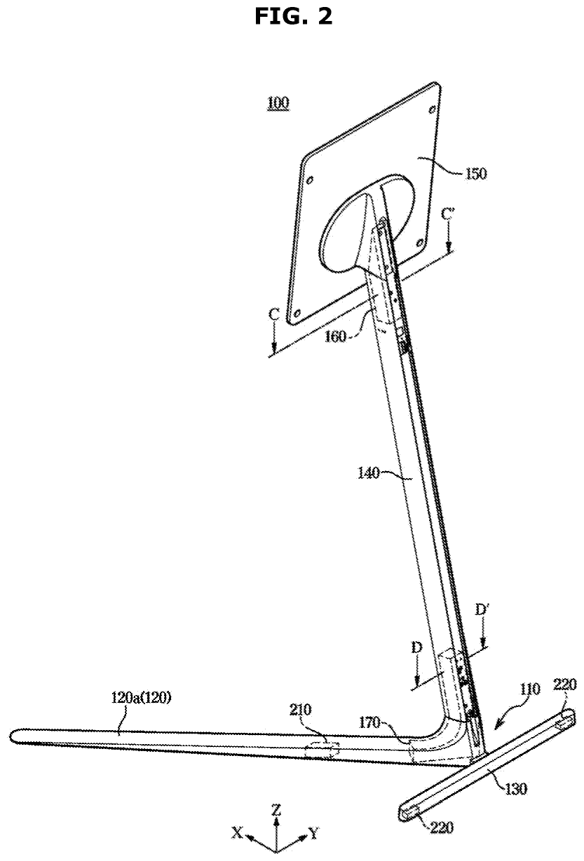

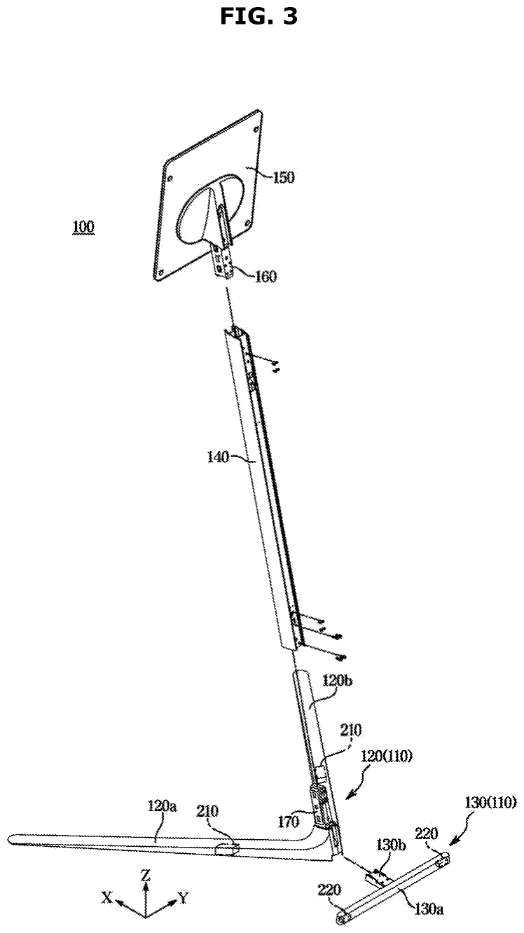

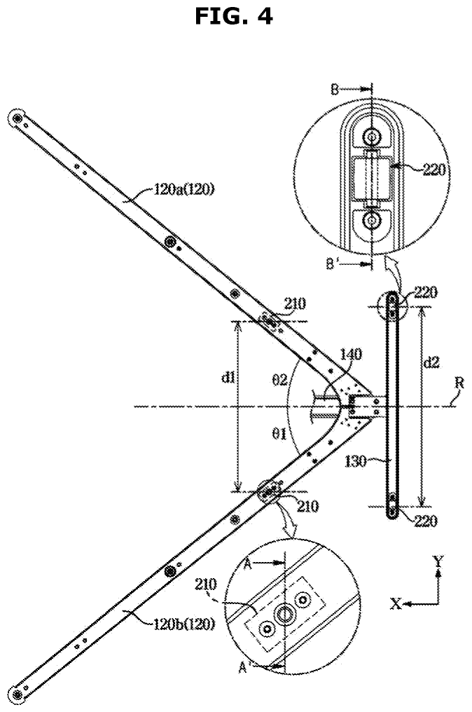

FIG. 2 is a perspective view illustrating a stand of the display apparatus according to an embodiment of the present disclosure, and FIG. 3 is an exploded perspective view illustrating the stand of the display apparatus according to an embodiment of the present disclosure. FIG. 4 is a view illustrating a rear surface of a base assembly in the stand of the display apparatus according to an embodiment of the present disclosure.

As illustrated in FIGS. 2 to 4, the stand 100 may include a base assembly 110 disposed on an installation surface.

The base assembly 110 may include a first base 120 and a second base 130 coupled to the first base 120. Suitably, the base assembly 110 may include a plurality of the first bases 120 and the second base 130 coupled to the plurality of first bases 120.

The plurality of first bases 120 may be positioned in the front of the second base 130 in a front-rear direction X of the stand 100. In another aspect, the plurality of first bases 120 may be positioned in the front of the second base 130 to direct to the same direction as the display module 10.

The plurality of first bases 120 may include a right base 120a and a left base 120b. Specifically, the right base 120a may be located on the right side with respect to a reference line R extending in the front-rear direction X of the stand 100 to pass through a support bar 140. The left base 120b may be located on the left side with respect to the reference line R extending in the front-rear direction X of the stand 100 to pass through the support bar 140. The right base 120a and the left base 120b may be joined to form a predetermined angle and disposed on an installation surface. In another aspect, the right base 120a may be biased to the right side with respect to the reference line R extending in the front-rear direction X of the stand 100 to pass through the support bar 140, and the left base 120b may be biased to the left side with respect to the reference line R extending in the front-rear direction X of the stand 100 to pass through the support bar 140. Suitably, an angle θ1 at which the left base 120b is biased with respect to the reference line R extending in the front-rear direction X of the stand 100 to pass through the support bar 140 and an angle θ2 at which the right base 120a is biased with respect to the reference line R extending in the front-rear direction X of the stand 100 to pass through the support bar 140 may be the same. That is, the left base 120b and the right base 120a may have a symmetrical structure with respect to the reference line R extending in the front-rear direction X of the stand 100 to pass through the support bar 140. However, an arrangement structure of the left base 120b and the right base 120a is not limited to the symmetrical structure. That is, the left base 120b and the right base 120a may be disposed on the installation surface such that the angle θ1 at which the left base 120b is biased with respect to the reference line R extending in the front-rear direction X of the stand 100 to pass through the support bar 140 and the angle θ2 at which the right base 120a is biased with respect to the reference line R extending in the front-rear direction X of the stand 100 to pass through the support bar 140 are different from each other.

A detailed description of a specific structure of the plurality of first bases 120 will be described later.

The second base 130 may be coupled to the plurality of first bases 120 to be located in the rear of the plurality of first bases 120 in the front-rear direction X of the stand 100. The second base 130 may be indirectly coupled to the plurality of first bases 120. Specifically, the second base 130 may be coupled to the plurality of first bases 120 via a second connection bracket 170.

The second base 130 may extend in a left-right direction Y of the stand 100. Specifically, the second base 130 may include a base body 130a extending in the left-right direction Y of the stand 100, and a base coupling part 130b extending from the base body 130a to be coupled to the plurality of first bases 120 via a second connection bracket 170.

The stand 100 may further include the support bar 140 extending in a height direction Z of the stand 100. The support bar 140 may be coupled to the base assembly 110. Specifically, the support bar 140 may be coupled to the base assembly 110 via the second connection bracket 170. The support bar 140 may have a column shape extending long along the height direction Z of the stand 100. However, the shape of the support bar 140 is not limited to the above example, and may be variously changed.

The stand 100 may further include a mount holder 150 provided to hold the display module 10. The mount holder 150 may be coupled to the support bar 140. Specifically, the mount holder 150 may be coupled to the support bar 140 via a first connection bracket 160. The display module 10 may be mounted on the mount holder 150.

A shelf (not shown) may be provided on the stand 100 for user convenience. Suitably, the shelf may be mounted on the support bar 140. As an example, a user may place and use an electronic product such as a laptop and a DVD player required for presentation or conference on a shelf.

The stand 100 may further include the first connection bracket 160 provided to connect the mount holder 150 and the support bar 140. One end of the first connection bracket 160 may be coupled to the mount holder 150, and the other end of the first connection bracket 160 may be accommodated in the support bar 140 and coupled to the support bar 140. A detailed description of a specific structure of the first connection bracket 160 will be described later.

The stand 100 may further include the second connection bracket 170 provided to connect the base assembly 110 and the support bar 140. One end of the second connection bracket 170 may be coupled to the base assembly 110, and the other end of the second connection bracket 170 may be accommodated in the support bar 140 and coupled to the support bar 140. The second connection bracket 170 may connect the plurality of first bases 120 and the second base 130. A detailed description of a specific structure of the second connection bracket 170 will be described later.

The stand 100 may further include at least one vibration damper. Suitably, the at least one vibration damper may include a first vibration damper 210 and a second vibration damper 220.

The first vibration damper 210 may be installed on the first base 120. Suitably, the stand 100 may include a plurality of the first vibration dampers 210. One of the plurality of first vibration dampers 210 may be installed on the right base 120a of the first base 120, and the other one of the plurality of first vibration dampers 210 may be installed on the left base 120b of the first base 120.

The second vibration damper 220 may be installed on the second base 130. Suitably, the stand 100 may include a plurality of the second vibration dampers 220. The plurality of second vibration dampers 220 may be installed on the second base 130 to be spaced apart from each other in the left-right direction Y of the stand 100. One of the plurality of second vibration dampers 220 may be installed at one end of the second base 130 facing the right base 120a of the first base 120, and the other one of the plurality of second vibration dampers 220 may be installed at the other end of the second base 130 facing the left base 120b of the first base 120.

The plurality of second vibration dampers 220 may be located outside the plurality of first vibration dampers 210 in the left-right direction Y of the stand 100. In other words, a distance d2 between the plurality of second vibration dampers 220 may be longer than a distance d1 between the plurality of first vibration dampers 210. In this case, the distance d1 between the plurality of first vibration dampers 210 and the distance d2 between the plurality of second vibration dampers 220 are measured based on the left-right direction Y of the stand 100. The distance d2 between the plurality of second vibration dampers 220 and the distance d1 between the plurality of first vibration dampers 210 may be the same.

When the second vibration damper 220 is installed at both ends of the second base 130 extending in the left-right direction Y of the stand 100, the second base 130 may be supported more stably on the installation surface. Accordingly, the stand 100 may be not easily fallen even when an external force is applied to the stand 100 toward the rear in the front-rear direction X of the stand 100.

A detailed description of a specific structures of the first vibration damper 210 and the second vibration damper 220 will be described later.

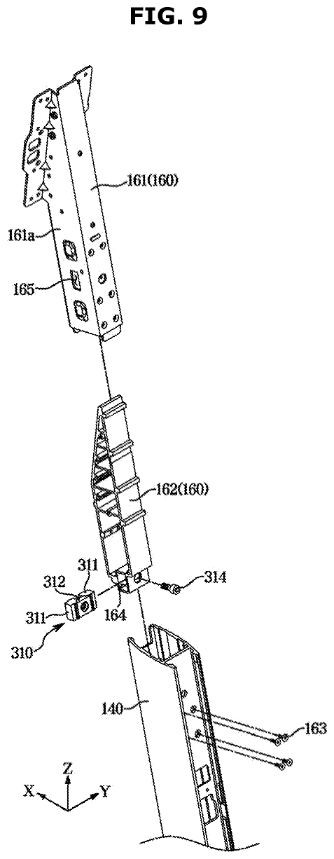

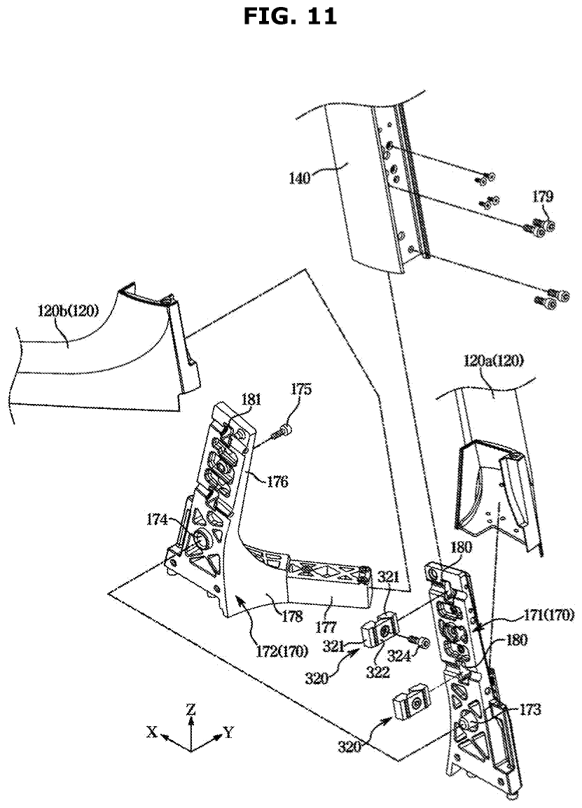

The stand 100 may further include at least one movement preventer. Suitably, the at least one movement preventer may include a first movement preventer 310 (see FIG. 9) and a second movement preventer 320 (see FIG. 11).

The first movement preventer 310 may be provided to reduce a gap between the first connection bracket 160 and the support bar 140. The first movement preventer 310 may be installed on the first connection bracket 160.

The second movement preventer 320 may be provided to reduce a gap between the second connection bracket 170 and the support bar 140. The second movement preventer 320 may be installed on the second connection bracket 170.

A detailed description of a specific structures of the first movement preventer 310 and the second movement preventer 320 will be described later.

When the coupling between the mount holder 150 and the support bar 140 is not firm, or the coupling between the base assembly 110 and the support bar 140 is not firm, the stand 100 may be shaken. In particular, the larger the gap between the first connection bracket 160, which connects the mount holder 150 and the support bar 140, and the support bar 140, and the larger the gap between the second connection bracket 170, which connects the base assembly 110 and the support bar 140, and the support bar 140, the greater a degree of shaking of the stand 100 may be. Such shaking of the stand 100 may cause inconvenience to a user and may lead to a safety accident. The at least one movement preventer minimizes the gap between the first connection bracket 160 and the support bar 140 or the gap between the second connection bracket 170 and the support bar 140, the shaking of the stand 100, in particular, the shaking of the support bar 140 may be effectively prevented.

The at least one vibration damper may not only dampen the vibration of the stand 100 together with the at least one movement preventer, but also enable the stable installation of the stand 100 on the installation surface regardless of the state of the installation surface. As an example, the at least one movement preventer may be elastically deformed so that the stand 100 may be stably installed on the installation surface even when the installation surface is uneven. In other words, the at least one vibration damper may dampen the vibration of the stand 100 by absorbing an external impact applied to the stand 100 and a vibration caused by the shaking of the stand 100, and may allow the stand 100 to be stably installed on the installation surface regardless of the state of the installation surface.

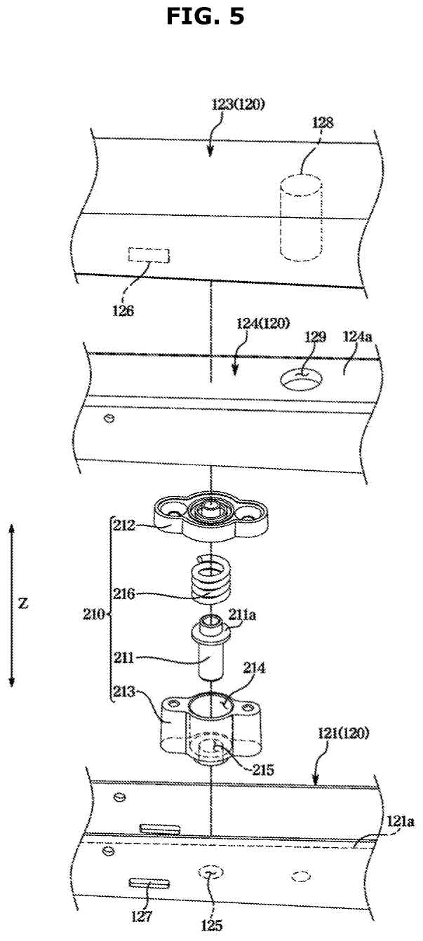

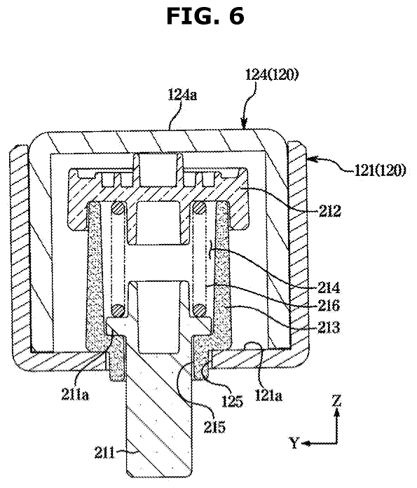

FIG. 5 is an exploded perspective view illustrating a first vibration damper in the stand of the display apparatus according to an embodiment of the present disclosure, and FIG. 6 is a cross-sectional view taken along line A-A′ in FIG. 4 illustrating the stand of the display apparatus according to an embodiment of the present disclosure.

As illustrated in FIGS. 5 and 6, the plurality of first vibration dampers 210 may be installed on the plurality of first bases 120 of the base assembly 110, respectively.

Each of the plurality of first bases 120 may include outer frames 121 and 123 forming an outer appearance and an inner frame 124 disposed inside the outer frames 121 and 123.

The outer frames 121 and 123 may include the bottom outer frame 121 and the top outer frame 123. A moving member passing hole 125 through which a moving member 211 of the plurality of first vibration dampers 210 passes may be formed on the bottom outer frame 121. The moving member passing hole 125 may be formed on a lower wall 121a of the bottom outer frame 121. The moving member 211 of the plurality of first vibration dampers 210 may be coupled by passing through the moving member passing hole 125 of the bottom outer frame 121 so as to move in the height direction Z of the stand 100. The top outer frame 123 may be coupled to the bottom outer frame 121 to form an outer appearance of the plurality of first bases 120 together with the bottom outer frame 121. The top outer frame 123 may be coupled to the bottom outer frame 121 such that the bottom outer frame 121 is located inside the top outer frame 123. Specifically, the top outer frame 123 and the bottom outer frame 121 may be coupled to each other by coupling between a locking part 126 protruding from an inner wall of the top outer frame 123 and a locking hole 127 formed on an outer wall of the bottom outer frame 121. The top outer frame 123 may include a coupling boss 128 extending in the height direction Z of the stand 100 to penetrate through and be coupled to the inner frame 124. The top outer frame 123, the inner frame 124, and the bottom outer frame 121 may be coupled to each other by a fixing member (not shown) penetrating the lower wall 121a of the bottom outer frame 121 and coupled to the coupling boss 128. The fixing member may include a screw.

The inner frame 124 may be disposed between the bottom outer frame 121 and the top outer frame 123. The inner frame 124 may include a boss coupling hole 129 through which the coupling boss 128 penetrates and is coupled. The inner frame 124 may be accommodated inside the bottom outer frame 121. The inner frame 124 may be coupled to a side wall of the bottom outer frame 121 by a fixing member (not shown) in a state of being accommodated inside the bottom outer frame 121. The fixing member may include a screw.

Each of the plurality of first vibration dampers 210 may include the moving member 211 exposed to the outside of the plurality of first bases 120 and provided to move in the height direction Z of the stand 100. Specifically, the moving member 211 may be provided to protrude to the outside of a lower wall of the plurality of first bases 120 as the moving member 211 moves in the height direction Z of the stand 100. The moving member 211 may penetrate through and be coupled to the moving member passing hole 125 of the bottom outer frame 121 of the plurality of first bases 120 to be exposed to the outside of the plurality of first bases 120. The moving member 211 may have a column shape. However, the shape of the moving member 211 is not limited to the above example and may be variously changed. The moving member 211 may include a separation preventing part 211a protruding from an outer circumferential surface of the moving member 211 in an outward direction of the moving member 211. The separation preventing part 211a has a larger width than a moving member coupling hole 215 of moving member holders 212 and 213 to prevent the moving member 211 from being separated from the moving member holders 212 and 213.

Each of the plurality of first vibration dampers 210 may further include the moving member holders 212 and 213 disposed inside the plurality of first bases 120 to hold the moving member 211. The moving member holders 212 and 213 may include the top holder 212 and the bottom holder 213 coupled to the top holder 212. The top holder 212 may be fixed to an inner surface of an upper wall 124a of the inner frame 124 directing upward of the stand 100. The bottom holder 213 may be fixed to an inner surface of the lower wall 121a of the bottom outer frame 121 facing the inner surface of the upper wall 124a of the inner frame 124. The bottom holder 213 may be coupled to the top holder 212 so that a first elastic body 216 is accommodated therein. The bottom holder 213 may include a moving member accommodating portion 214 provided to accommodate the moving member 211. The bottom holder 213 may further include a moving member coupling hole 215 to which the moving member 211 is coupled. The moving member coupling hole 215 may be formed on a bottom of the moving member accommodating portion 214.

Each of the plurality of first vibration dampers 210 may further include a first elastic body 216 installed inside the moving member holders 212 and 213 to elastically support the moving member 211. As an example, the first elastic body 216 may include a spring. The first elastic body 216 is elastically deformable in the height direction Z of the stand 100. One end of the first elastic body 216 may be coupled to the top holder 212, and the other end of the first elastic body 216 may be coupled to the moving member 211. Suitably, the other end of the first elastic body 216 may be coupled to the separation preventing part 211a of the moving member 211.

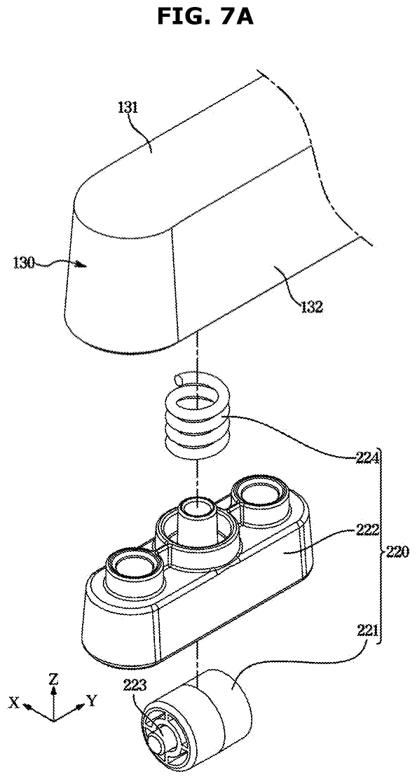

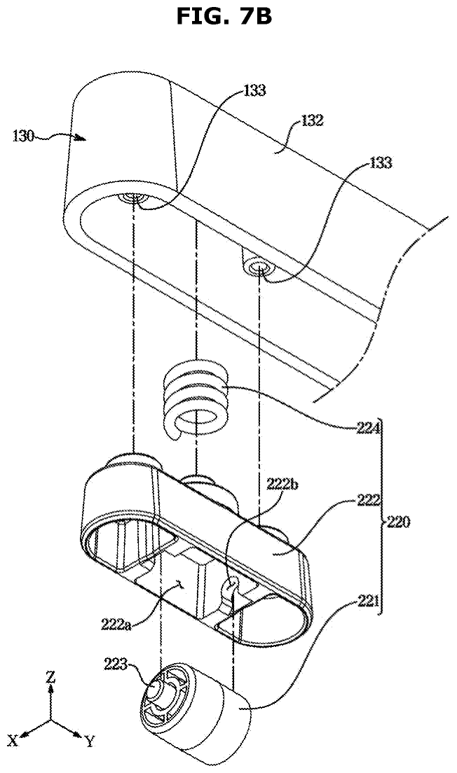

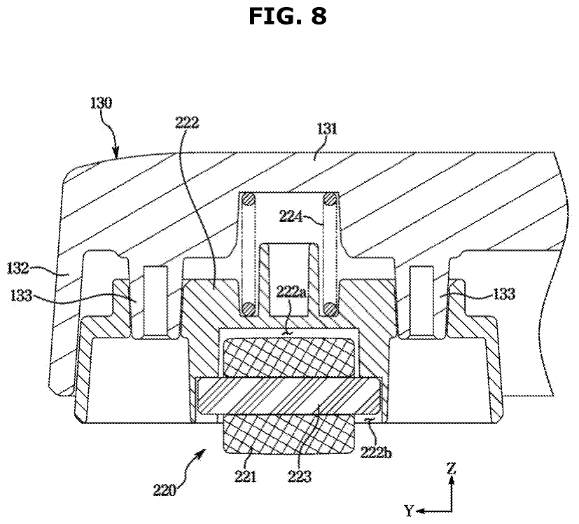

FIGS. 7a and 7b are exploded perspective views illustrating a second vibration damper in different directions in the stand of the display apparatus according to an embodiment of the present disclosure, and FIG. 8 is a cross-sectional view taken along line B-B′ in FIG. 4 illustrating the stand of the display apparatus according to an embodiment of the present disclosure.

As illustrated in FIGS. 7a to 8, the plurality of second vibration dampers 220 may be installed on the second base 130.

The second base 130 may include an upper wall 131 and a side wall 132 forming an outer appearance of the second base 130 together with the upper wall 131. The second base 130 may have an open lower wall. The second base 130 may further include a fastening boss 133 extending from the upper wall 131 in the height direction Z of the stand 100.

Each of the plurality of second vibration dampers 220 may include a rotation member 221 provided to exposed to the outside of the second base 130 and move in the height direction Z of the stand 100. The rotation member 221 may be rotatably provided to impart mobility to the stand 100.

Each of the plurality of second vibration dampers 220 may further include a rotation member holder 222 provided such that the rotation member 221 is seated therein and to be coupled to the second base 130. Specifically, the rotation member holder 222 may be coupled to the fastening boss 133 of the second base 130 by a fixing member (not shown). The rotation member holder 222 may be located inside the second base 130. The rotation member holder 222 may include a rotation member seating portion 222a in which the rotation member 221 is seated and a shaft seating portion 222b in which a rotation shaft 223 is seated. The rotation member seating portion 222a and the shaft seating portion 222b may be formed to be recessed in a lower wall of the rotation member holder 222.

Each of the plurality of second vibration dampers 220 may further include the rotation shaft 223 seated in the rotation member holder 222 so that the rotation member 221 is rotatably coupled. Specifically, the rotation member 221 may penetrate through and be coupled to the rotation shaft 223, and the rotation shaft 223 may be seated in the shaft seating portion 222b of the rotation member holder 222. The rotation shaft 223 may extend in the left-right direction Y of the stand 100. In other words, the rotation shaft 223 may extend in a longitudinal direction of the second base 130.

Each of the plurality of second vibration dampers 220 may further include a second elastic body 224 installed between the upper wall 131 of the second base 130 and the rotation member holder 222 to elastically support the rotation member 221. As an example, the second elastic body 224 may include a spring. The second elastic body 224 is elastically deformable in the height direction Z of the stand 100. One end of the second elastic body 224 may be coupled to the upper wall 131 of the second base 130, and the other end of the second elastic body 224 may be coupled to the rotation member holder 222.

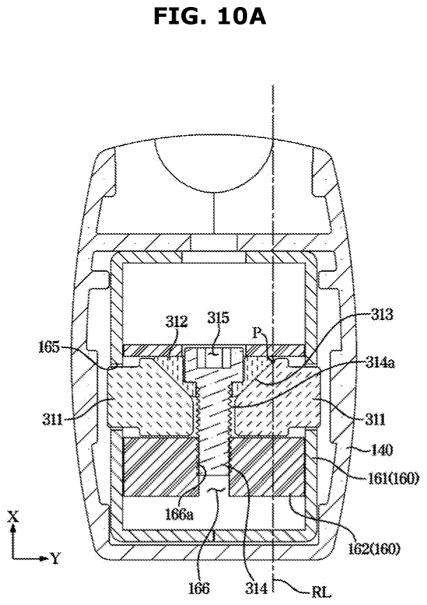

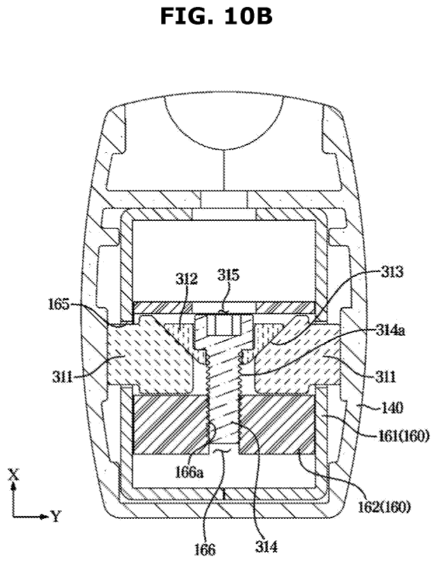

FIG. 9 is an exploded perspective view of a part of the stand of the display apparatus according to an embodiment of the present disclosure, and FIGS. 10a and 10b are views illustrating an operation process of a first movement preventer in the stand of the display apparatus according to an embodiment of the present disclosure. For reference, FIGS. 10a and 10b are cross-sectional views taken along line C-C′ in FIG. 2 illustrating the stand of the display apparatus according to an embodiment of the present disclosure.

As illustrated in FIGS. 9 to 10b, the first movement preventer 310 may be installed on the first connection bracket 160.

The first connection bracket 160 may be provided to connect the mount holder 150 and the support bar 140. The first connection bracket 160 may include an outer bracket 161 and an inner bracket 162 disposed inside the outer bracket 161. The inner bracket 162 may be coupled to the outer bracket 161 by a fixing member (not shown) penetrating a side wall of the outer bracket 161 and a side wall of the inner bracket 162 to be located inside the outer bracket 161. As an example, the fixing member may include a screw. One end of the outer bracket 161 may be coupled to the mount holder 150, and the other end of the outer bracket 161 may be accommodated in the support bar 140 and coupled to the support bar 140. Specifically, the other end of the outer bracket 161 may be coupled to the support bar 140 to be located inside the support bar 140 by a fixing member 163. As an example, the fixing member 163 may include a screw. The fixing member 163 may sequentially penetrate the support bar 140 and the outer bracket 161 from the rear of the stand 100 to couple the support bar 140 and the outer bracket 161 to each other. The inner bracket 162 may include a first movement preventer accommodation space 164 in which the first movement preventer 310 is accommodated.

The first connection bracket 160 may further include an opening 165. The opening 165 may be formed on a side wall of the first connection bracket 160. Specifically, the opening 165 may be formed on a side wall 161a of the outer bracket 161 of the first connection bracket 160. A side wall of the inner bracket 162 corresponding to the opening 165 formed in the outer bracket 161 may be open. In other words, the first movement preventer accommodation space 164 may include an open side wall.

The first movement preventer 310 may include a moving block 311 provided to enable to protrude through the opening 165 of the first connection bracket 160 to come into contact with an inner surface of the support bar 140. Suitably, the first movement preventer 310 may include a plurality of the moving blocks 311. The plurality of moving blocks 311 may be disposed to be spaced apart from each other in the left-right direction Y of the stand 100.

The first movement preventer 310 may further include a guide block 312 having an inclined surface 313 along which the moving block 311 moves. The guide block 312 may be disposed between the plurality of moving blocks 311. The inclined surface 313 of the guide block 312 may be formed to be inclined in an inner direction of the guide block 312 with respect to the reference line RL extending in the front-rear direction X of the stand 100 to pass through a rear end P of the guide block 312 adjacent to the moving block 311.

The first movement preventer 310 may further include a guide pin 314 provided to enable to press the guide block 312 from the rear of the stand 100. The guide pin 314 may penetrate through and be coupled to the guide block 312 in the front-rear direction X of the stand 100. The guide pin 314 may be coupled to a pin coupling hole 166 formed on a front wall of the inner bracket 162 of the first connection bracket 160 by sequentially penetrating a rear wall of the support bar 140, a rear wall of the outer bracket 161 of the first connection bracket 160, a rear wall of the inner bracket 162 of the first connection bracket 160, and the guide block 312 from the rear of the stand 100. A first screw thread 314a may be formed on the guide pin 314, and a second screw thread 166a corresponding to the first screw thread 314a of the guide pin 314 may be formed on an inner circumferential surface of the pin coupling hole 166. When the guide pin 314 is coupled to the pin coupling hole 166 of the inner bracket 162, the first screw thread 314a of the guide pin 314 may be engaged with the second screw thread 166a of the pin coupling hole 166.

As illustrated in FIGS. 10a and 10b, the guide pin 314 of the first movement preventer 310 may be pressed from the rear of the stand 100 using a tool (not shown). As an example, the tool may include a hexagon wrench and may be fastened to a fastening groove 315 formed on the guide pin 314. When the tool is rotated in a state of being fastened to the fastening groove 315 of the guide pin 314, the guide pin 314 moves forward in the front-rear direction X of the stand 100. The guide block 312 may move forward in the front-rear direction X of the stand 100 integrally with the guide pin 314, and the plurality of moving blocks 311 adjacent to the guide block 312 may move along the inclined surface 313 of the guide block 312 and protrude through the opening 165 of the first connection bracket 160. The plurality of moving blocks 311 protruding through the opening 165 of the first connection bracket 160 may come into contact with the inner surface of the support bar 140. As such, as the plurality of moving blocks 311 is in close contact with the inner surface of the support bar 140, the gap between the first connection bracket 160 and the support bar 140 may be reduced.

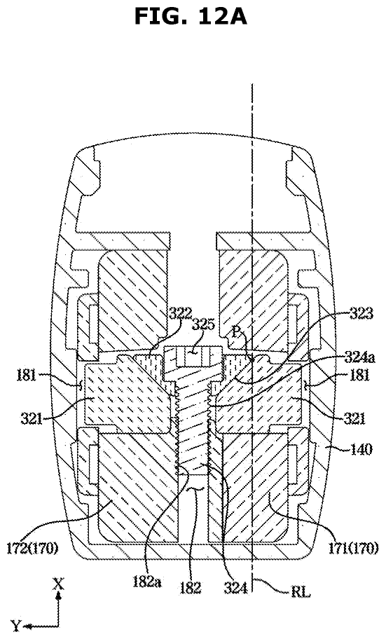

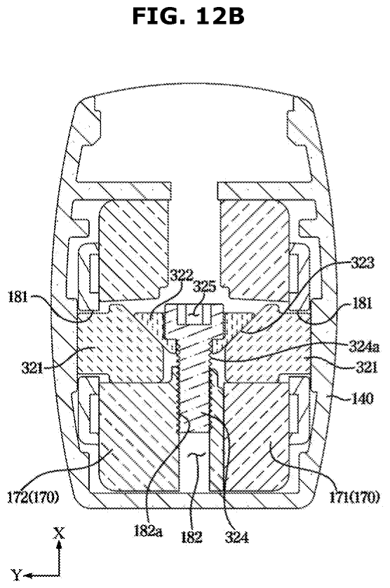

FIG. 11 is an exploded perspective view of another part of the stand of the display apparatus according to an embodiment of the present disclosure, and FIGS. 12a and 12b are views illustrating an operation process of a second movement preventer in the stand of the display apparatus according to an embodiment of the present disclosure. For reference, FIGS. 12a and 12b are cross-sectional views taken along line D-D′ in FIG. 2 illustrating the stand of the display apparatus according to an embodiment of the present disclosure.

As illustrated in FIGS. 11 to 12b, the second movement preventer 320 may be installed on the second connection bracket 170.

The second connection bracket 170 may be provided to connect the base assembly 110 and the support bar 140. Specifically, the second connection bracket 170 may be provided to connect the plurality of first bases 120 and the support bar 140. Suitably, the second connection bracket 170 may include a right connection bracket 171 provided to connect the right base 120a and the support bar 140, and a left connection bracket 172 provided to connect the left base 120b and the support bar 140. As a coupling protrusion 173 formed on one of the right connection bracket 171 and the left connection bracket 172 is coupled to a coupling groove 174 formed on the other of the right connection bracket 171 and the left connection bracket 172, the right connection bracket 171 and the left connection bracket 172 may be firstly coupled to each other. Specifically, as the coupling protrusion 173 formed on one of an inner surface of a support bar coupling part 176 of the right connection bracket 171 and the inner surface of the support bar coupling part 176 of the left connection bracket 172 is coupled to the coupling groove 174 formed on the other of the inner surface of the support bar coupling part 176 of the right connection bracket 171 and the inner surface of the support bar coupling part 176 of the left connection bracket 172, the right connection bracket 171 and the left connection bracket 172 may be firstly coupled to each other. The right connection bracket 171 and the left connection bracket 172 may be secondly coupled to each other by a fixing member 175 coupled in the left-right direction Y of the stand 100. As an example, the fixing member 175 may include a screw.

The second connection bracket 170 may include the support bar coupling part 176 coupled to the support bar 140 by a fixing member 179, a base coupling part 177 coupled to the plurality of first bases 120 of the base assembly 110 by a fixing member (not shown), and a connection part 178 to connect the support bar coupling part 176 and the base coupling part 177. The support bar coupling part 176 of the second connection bracket 170 may be coupled to the support bar 140 by the fixing member 179 that penetrates through and is coupled to a rear surface of the support bar 140 from a rear of the stand 100 in a state of being inserted into the support bar 140. As an example, the fixing member 179 may include a screw. The base coupling part 177 of the second connection bracket 170 may be coupled to the inner frames 124 of the plurality of first bases 120 by a fixing member. The connection part 178 of the second connection bracket 170 may be covered by the top outer frames 123 of the plurality of first bases 120.

The second connection bracket 170 may include a second movement preventer seating part 180 on which the second movement preventer 320 is seated. The second movement preventer seating part 180 may be formed on the support bar coupling part 176 of the second connection bracket 170. Specifically, the second movement preventer seating part 180 may be formed by the support bar coupling part 176 of the right connection bracket 171 and the support bar coupling part 176 of the left connection bracket 172. That is, the second movement preventer 320 may be disposed between the support bar coupling part 176 of the right connection bracket 171 and the support bar coupling part 176 of the left connection bracket 172.

The second connection bracket 170 may include an opening 181. Specifically, the opening 181 may be formed on the support bar coupling part 176 of the second connection bracket 170. More specifically, the opening 181 may be formed on a side wall of the support bar coupling part 176 of the second connection bracket 170.

The second movement preventer 320 may include a moving block 321 provided to enable to protrude through the opening 181 of the second connection bracket 170 to come into contact with the inner surface of the support bar 140. Suitably, the second movement preventer 320 may include a plurality of the moving blocks 321. The plurality of moving blocks 321 may be disposed to be spaced apart from each other in the left-right direction Y of the stand 100.

The second movement preventer 320 may further include a guide block 322 having an inclined surface 323 along which the moving block 321 moves. The guide block 322 may be disposed between a plurality of the moving blocks 321. The inclined surface 323 of the guide block 322 may be formed to be inclined in an inner direction of the guide block 322 with respect to the reference line RL extending in the front-rear direction X of the stand 100 to pass through the rear end P of the guide block 322 adjacent to the moving block 321.

The second movement preventer 320 may further include a guide pin 324 provided to enable to press the guide block 322 from the rear of the stand 100. The guide pin 324 may penetrate through and be coupled to the guide block 322 in the front-rear direction X of the stand 100. The guide pin 324 may be coupled to a pin coupling hole 182 formed on an inner surface of the second connection bracket 170 by sequentially penetrating the rear wall of the support bar 140, a rear wall of the second connection bracket 170, and the guide block 322 from the rear of the stand 100. Specifically, the pin coupling hole 182 may be formed on the inner surface of the support bar coupling part 176 of the second connection bracket 170. In another aspect, the pin coupling hole 182 may be formed at a protruding portion of one of the inner surface of the support bar coupling part 176 of the right connection bracket 171 and the inner surface of the support bar coupling part 176 of the left connection bracket 172. A first screw thread 324a may be formed on the guide pin 324, and a second screw thread 182a corresponding to the first screw thread 324a of the guide pin 324 may be formed on an inner circumferential surface of the pin coupling hole 182. When the guide pin 324 is coupled to the pin coupling hole 182 of the second connection bracket 170, the first screw thread 324a of the guide pin 324 may be engaged with the second screw thread 182a of the pin coupling hole 182.

The second movement preventer 320 may include a plurality of movement preventers disposed in the height direction Z of the stand 100. As an example, the second movement preventer 320 may include an upper movement preventer positioned at an upper side and a lower movement preventer positioned at a lower side in the height direction Z of the stand 100. However, it is sufficient if the number of the second movement preventers 320 is more than one, and is not limited to the above example.

As illustrated in FIGS. 12a and 12b, the guide pin 324 of the second movement preventer 320 may be pressed from the rear of the stand 100 using a tool (not shown). As an example, the tool may include a hexagon wrench and may be fastened to a fastening groove 325 formed on the guide pin 324. When the tool is rotated in a state of being fastened to the fastening groove 325 of the guide pin 324, the guide pin 324 moves forward in the front-rear direction X of the stand 100. The guide block 322 may move forward in the front-rear direction X of the stand 100 integrally with the guide pin 324, and the plurality of moving blocks 321 adjacent to the guide block 322 may move along the inclined surface 323 of the guide block 322 and protrude through the opening 181 of the second connection bracket 170. The plurality of moving blocks 321 protruding through the opening 181 of the second connection bracket 170 may come into contact with the inner surface of the support bar 140. As such, as the plurality of moving blocks 321 is in close contact with the inner surface of the support bar 140, the gap between the second connection bracket 170 and the support bar 140 may be reduced.

The foregoing has illustrated and described specific embodiments. However, it should be understood by those of skilled in the art that the disclosure is not limited to the above-described embodiments, and various changes and modifications may be made without departing from the technical idea of the disclosure described in the following claims.

1. A stand configured to support a display module, wherein
the stand comprises:
a base assembly comprising a first base and a second base coupled to the first base;
a support bar extending in a height direction of the stand to be coupled to the base assembly;
a first vibration damper installed on the first base, the first vibration damper comprising a moving member exposed to the outside of the first base and provided to move in the height direction of the stand; and
a second vibration damper installed on the second base, the second vibration damper comprising a rotation member provided to exposed to the outside of the second base and move in the height direction of the stand and rotatably provided to impart mobility to the stand.

2. The stand according to claim 1, wherein
the first vibration damper further comprises:
a moving member holder disposed inside the first base to hold the moving member; and
a first elastic body installed inside the moving member holder to elastically support the moving member.

3. The stand according to claim 2, wherein
the first base comprises:
a bottom outer frame having a moving member passing hole through which the moving member passes;
a top outer frame coupled to the bottom outer frame to form an outer appearance of the first base together with the bottom outer frame; and
an inner frame disposed between the bottom outer frame and the top outer frame.

4. The stand according to claim 3, wherein
the moving member holder comprises:
a top holder fixed to an inner surface of an upper wall of the inner frame directing upward of the stand; and
a bottom holder fixed to an inner surface of a lower wall of the bottom outer frame facing the inner surface of the upper wall of the inner frame, coupled to the top holder so that the first elastic body is accommodated therein, and comprising a moving member coupling hole to which the moving member is coupled.

5. The stand according to claim 4, wherein
the first elastic body is elastically deformable in the height direction of the stand, and
one end of the first elastic body is coupled to the top holder, and the other end of the first elastic body is coupled to the moving member.

6. The stand according to claim 1, wherein
the first base is positioned in the front of the second base to direct to the same direction as the display module.

7. The stand according to claim 1, wherein
the second base extends in a left-right direction of the stand, and
the second vibration damper comprises:
a rotation member holder provided to seat the rotation member and coupled to the second base; and
a rotation shaft seated on the rotation member holder so that the rotation member is rotatably coupled and extending in a left-right direction of the stand.

8. The stand according to claim 7, wherein
the second vibration damper further comprises a second elastic body installed between an upper wall of the second base and the rotation member holder to elastically support the rotation member.

9. The stand according to claim 8, wherein
the second elastic body is elastically deformable in the height direction of the stand, and
one end of the second elastic body is coupled to the upper wall of the second base, and the other end of the second elastic body is coupled to the rotation member holder.

10. The stand according to claim 1, further comprising:
a mount holder provided to mount the display module thereon;
a first connection bracket having one end coupled to the mount holder and the other end being accommodated in and coupled to the support bar, to connect the mount holder and the support bar, the first connection bracket having an opening; and
a first movement preventer provided to reduce a gap between the first connection bracket and the support bar, the first movement preventer comprising a moving block provided to enable to protrude through the opening of the first connection bracket to come into contact with an inner surface of the support bar.

11. The stand according to claim 10, wherein
the first movement preventer further comprises:
a guide block having an inclined surface along which the moving block moves; and
a guide pin penetrating through and coupled to the guide block in a front-rear direction of the stand and provided to enable to press the guide block from the rear of the stand.

12. The stand according to claim 11, wherein
when the guide pin is pressed from the rear of the stand, the moving block moves along the inclined surface of the guide block to protrude through the opening of the first connection bracket.

13. The stand according to claim 1, further comprising:
a second connection bracket having one end coupled to the base assembly and the other end being accommodated in and coupled to the support bar, to connect the base assembly and the support bar, the second connection bracket having an opening; and
a second movement preventer provided to reduce a gap between the second connection bracket and the support bar, the second movement preventer comprising a moving block provided to enable to protrude through the opening of the second connection bracket to come into contact with an inner surface of the support bar.

14. The stand according to claim 13, wherein
the second movement preventer further comprises:
a guide block having an inclined surface along which the moving block moves; and
a guide pin penetrating through and coupled to the guide block in a front-rear direction of the stand and provided to enable to press the guide block from the rear of the stand.

15. The stand according to claim 14, wherein
when the guide pin is pressed from the rear of the stand, the moving block moves along the inclined surface of the guide block to protrude through the opening of the second connection bracket.
